(19) United States
(12) Patent Application Publication
(10) Pub. No.: US 2026/0180662 A1
(43) Pub. Date: Jun. 25, 2026

(54) BEAM SELECTION FOR SATELLITE-BASED DIRECT TO CELLULAR COMMUNICATIONS

(71) Applicant: AT&T Intellectual Property I, L.P., Atlanta, GA (US)

(72) Inventors: Yupeng Jia, South Pasadena, CA (US); Hongyan Lei, Plano, TX (US)

(21) Appl. No.: 18/991,679

(22) Filed: Dec. 22, 2024

(51) Int. Cl. H04B 7/06; H04B 7/185

(52) U.S. Cl. CPC H04B 7/06952; H04B 7/18539; H04B 7/18547

(57) ABSTRACT

A processing system including at least one processor of a cellular endpoint device may obtain information regarding a plurality of non-terrestrial network nodes of a non-terrestrial network, where the information may include channel bandwidth information for each of the plurality of non-terrestrial network nodes. The processing system may next select, based on the information regarding the plurality of non-terrestrial network nodes, at least one beam of at least one non-terrestrial network node from among the plurality of non-terrestrial network nodes for establishing a cellular network connection via the non-terrestrial network. The processing system may then establish the cellular network connection via the at least one beam.

The present disclosure relates generally to satellite access for cellular networks, and more particularly to methods, non-transitory computer-readable media, and apparatuses for selecting at least one beam of at least one non-terrestrial network node from among a plurality of non-terrestrial network nodes for establishing a cellular network connection for a cellular endpoint device based on information regarding the plurality of non-terrestrial network nodes including channel bandwidth information.

### BACKGROUND

Modern society may increasingly expect continuous network connectivity at any time of the day and day of the week. In many cases, a loss of connectivity may be considered an emergency. For example, first responders, governmental entities, medical facilities, home medical devices, and others may rely on consistent connectivity in order to function. In addition, small cells and wireless access points are increasingly prevalent. However, wireless access points and small cells may still assume access is available to wired infrastructure capable of supporting high data rates, which may still remain infeasible in many areas of the world.

### SUMMARY

In one example, the present disclosure discloses a method, computer-readable medium, and apparatus for selecting at least one beam of at least one non-terrestrial network node from among a plurality of non-terrestrial network nodes for establishing a cellular network connection for a cellular endpoint device based on information regarding the plurality of non-terrestrial network nodes including channel bandwidth information. For example, a processing system including at least one processor of a cellular endpoint device may obtain information regarding a plurality of non-terrestrial network nodes of a non-terrestrial network, where the information may include channel bandwidth information for each of the plurality of non-terrestrial network nodes. The processing system may next select, based on the information regarding the plurality of non-terrestrial network nodes, at least one beam of at least one non-terrestrial network node from among the plurality of non-terrestrial network nodes for establishing a cellular network connection via the non-terrestrial network. The processing system may then establish the cellular network connection via the at least one beam.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for selecting at least one beam of at least one non-terrestrial network node from among a plurality of non-terrestrial network nodes for establishing a cellular network connection for a cellular endpoint device based on information regarding the plurality of non-terrestrial network nodes including channel bandwidth information; and

FIG. 3 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for selecting at least one beam of at least one non-terrestrial network node from among a plurality of non-terrestrial network nodes for establishing a cellular network connection for a cellular endpoint device based on information regarding the plurality of non-terrestrial network nodes including channel bandwidth information. In particular, examples of the present disclosure describe cellular endpoint devices that are provided with an additional non-terrestrial network (NTN)-based access to a cellular network, where the cellular endpoint devices may perform beam selection across beams of one or more NTN nodes (e.g., satellites). For a given cellular endpoint device, beam selection may account for cellular endpoint device movement (including velocity, direction of movement, etc.) and/or battery life for both idle and non-idle modes. Examples of the present disclosure are particularly suited for improving user experience for cellular endpoint devices in remote or disaster-prone areas.

Satellite access has become an essential component of user connectivity, especially in remote areas. For instance, a non-terrestrial network (NTN) (e.g., a satellite access network (SAN)) can extend cellular coverage to areas where a terrestrial cellular network is not available or not economically viable. In addition, during natural disasters, satellite connectivity may comprise an important backup option to provide connectivity where terrestrial cellular infrastructure has been damaged. With even more satellite launches to meet increased demand, endpoint devices in some scenarios may be in an area covered by multiple satellites or satellite beams. In accordance with the present disclosure, handover procedures may allow endpoint devices to switch from one satellite or beam to another to maintain uninterrupted connectivity. Additional considerations may be involved in idle mode satellite/beam selection to ensure that an endpoint device selects the best satellite or beam for communication when not actively in use.

To illustrate, in one example, a cellular endpoint device may be configured to measure signal strength from the surrounding satellites and/or beams and to execute a handover to a satellite and/or to a beam thereof with the best signal quality. When a user initiates a phone call or sends a text message, the signal is transmitted to the satellite with the best signal quality, which is often the nearest satellite. The satellite may then relay the call or text message to a ground station or to another satellite with a better connection to a ground station. This can reduce the connection time for satellite connectivity while providing satellite coverage to a larger area.

In one example, a cellular endpoint device may perform handover prediction based on cellular endpoint device velocity and positioning. For instance, the cellular endpoint device may use a velocity sensor or global positioning system (GPS) unit to track movement over time, which may be used to predict future movement and to perform proactive handover to ensure seamless connectivity. In particular, the cellular endpoint device may perform a handover to the satellite or satellite beam with the best signal quality based on the predicted future movement. In one example, before initiating a handover, a cellular endpoint device may establish a connection with a neighboring satellite and prepare for a transfer of a cellular network connection. The cellular endpoint device and/or the satellite(s) may determine an optimal time to initiate the handover process to minimize the disruption during the transfer and to ensure a seamless and uninterrupted service to the cellular endpoint device.

Examples of the present disclosure further include idle mode satellite selection based on signal strength or preferred satellite/frequency bands. For instance, idle mode satellite selection may be based on a list of preferred satellites or beams and/or the cellular endpoint device may select the one with the highest signal strength. Alternatively, or in addition, a cellular endpoint device may select a satellite and/or a beam in consideration of battery/power consumption objectives. For instance, the cellular endpoint device may preferentially switch/connect to a satellite or satellite beam with a narrower channel bandwidth. In one example, for further power savings, the cellular endpoint device may also switch to sparse control channel monitoring. For instance, the cellular endpoint device may scan for a physical downlink control channel (PDCCH) less frequently or may search within a narrower frequency band. After the selection and handover, the signal strength and quality over the beam can be re-evaluated to ensure that the connection is stable and optimal. If necessary, adjustment can be made to optimize the selection and handover process further.

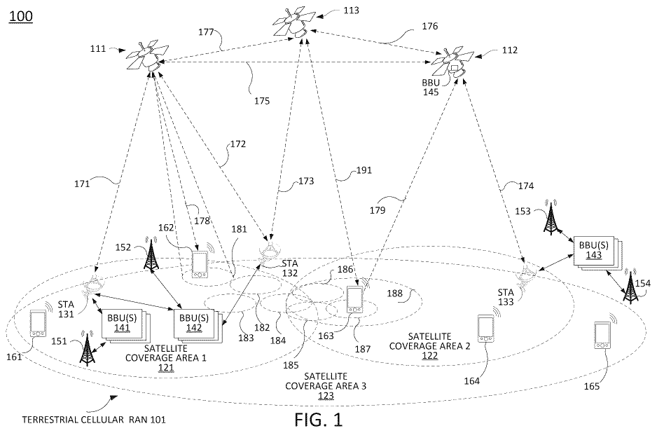

Thus, examples of the present disclosure provide endpoint devices (e.g., cellular endpoint devices) with enhanced satellite access network connection capabilities, e.g., where endpoint devices may implement inter-satellite (an/or inter-beam) handovers based on endpoint device velocity and positioning, satellite or beam signal strength, channel bandwidths, satellite and/or beam load, user/device preferences for particular satellites (or beams), battery capacity and/or preferences related to battery and power consumption, and so forth. Accordingly, examples of the present disclosure may contribute to a robust and scalable cellular network (or cellular/NTN hybrid network) capable of meeting evolving user demands. It should also be noted that the term “non-terrestrial network” (NTN) represents a plethora of connection scenarios, including satellite-based communications via airborne stations, air-to-ground or uncrewed aerial vehicles (UAV) flight control, and so forth. Thus, examples of the present disclosure are not limited to satellite communications but may also be expanded to air to ground or UAVs, balloons, etc. These and other aspects of the present disclosure are discussed in greater detail below in connection with the examples of FIGS. 1-3.

FIG. 1 illustrates an example network, or system 100 in which examples of the present disclosure may operate. In one example, the system 100 includes a terrestrial cellular radio access network (RAN) 101 (e.g., a 5G RAN, a 5G/4G/Long Term Evolution (LTE) hybrid RAN, an evolved Universal Terrestrial Radio Access Network (eUTRAN), or the like). In one example, the terrestrial cellular radio access network (RAN) 101 may comprise a cloud RAN. For instance, a cloud RAN is part of the 3^{rd} Generation Partnership Project (3GPP) 5G specifications for mobile networks. As part of the progression of mobile/cellular networks towards 5G, a cloud RAN may be coupled to a 5G core network and/or to an Evolved Packet Core (EPC) network until new cellular core networks are deployed in accordance with 5G specifications.

To further illustrate, the terrestrial cellular RAN 101 may include a plurality of cell sites 151-154, which may each comprise a radio unit (RU) or remote radio head (RRH) of a cellular base station, e.g., a gNodeB, or gNB. In addition, the terrestrial cellular RAN 101 may include a plurality of baseband units (BBUs) 141-143, which may be associated with one or more cellular base stations (e.g., gNBs). For instance, the BBUs 141-143 may represent one or more distributed units (DUs) and/or one or more centralized units (CUs) assigned to one or more cellular base stations and/or cell sites. It should be noted that in accordance with an Open-Radio Access Network (ORAN) architecture, CUs and DUs may be disaggregated and deployed on computing resources at different physical locations. However, for ease of illustration, these components are represented collectively as BBUs (e.g., BBUs 141-143, illustrated as BBU pools).

In particular, a BBU pool may be located at distances as far as 20-80 kilometers or more away from the antennas/remote radio heads of cell sites that are serviced by the BBU pool. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less. Although cloud RAN infrastructure may include distributed RRHs and centralized baseband units, a heterogeneous network may include cell sites where RRH and BBU components remain co-located at the cell site. For instance, a cell site may include RRH and BBU components and may thus comprise a self-contained “base station.”

FIG. 1 also illustrates various endpoint devices 161-165, e.g., user equipment (UEs) such as cellular endpoint devices. For instance, endpoint devices 161-165 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing devices (broadly, “an endpoint device”). In one example, endpoint devices 161-165 may each be equipped with one or more directional antennas, or antenna arrays (e.g., having a half-power azimuthal beamwidth of 120 degrees or less, 90 degrees or less, 60 degrees or less, etc.), e.g., multiple input-multiple output (MIMO) antenna(s) to receive multi-path and/or spatial diversity signals. Some or all of the endpoint devices 161-165 may also include a gyroscope and compass to determine orientation(s), a global positioning system (GPS) receiver for determining a location (e.g., in latitude and longitude, or the like), and so forth. In one example, some or all of the endpoint devices 161-165 may include a built-in/embedded barometer from which measurements may be taken and from which an altitude or elevation of the respective endpoint device may be determined. In one example, some or all of the endpoint devices 161-165 may also be configured to determine location/position from near field communication (NFC) technologies, such as Wi-Fi direct and/or other Institute of Electrical and Electronics Engineers (IEEE) 802.11 communications or sensing (e.g., in relation to beacons or reference points in an environment), IEEE 802.15 based communications or sensing (e.g., “Bluetooth™,” “ZigBee™,” etc.), and so forth.

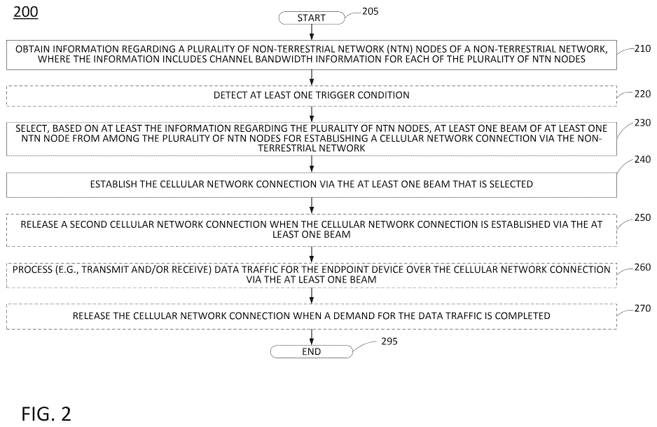

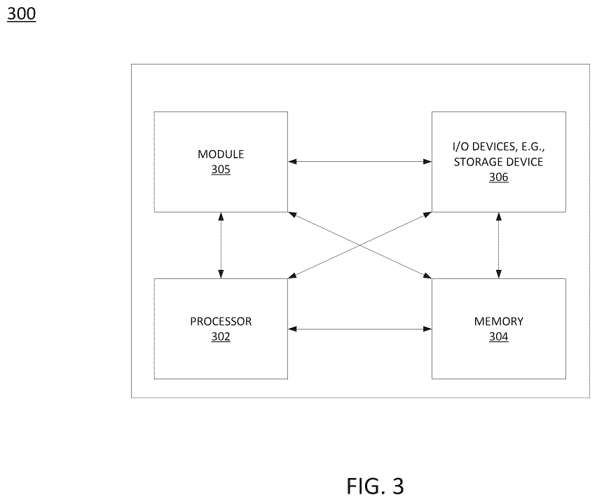

In one example, each of endpoint devices 161-165 may comprise all or a portion of a computing system, such as computing system 300 depicted in FIG. 3, and may be configured to perform one or more steps, functions, and/or operations in connection with examples of the present disclosure for selecting at least one beam of at least one non-terrestrial network node from among a plurality of non-terrestrial network nodes for establishing a cellular network connection for an endpoint device based on information regarding the plurality of non-terrestrial network nodes including channel bandwidth information, such as illustrated and described in connection with the example method 200 of FIG. 2. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

As further illustrated in FIG. 1, the system 100 includes non-terrestrial network (NTN) nodes 111-113 (e.g., satellites), each having a respective satellite coverage areas 1-3 (121-123). The NTN nodes 111-113 together with ground stations (STA) 131-133 may comprise a non-terrestrial network (NTN), e.g., a satellite network. Notably, 3GPP standards (e.g., release 17 and beyond) expand the concept of cellular services over non-terrestrial networks in which satellites or other NTN nodes may include 3GPP new radio (NR) compliant technologies. For instance, in the example of FIG. 1, satellites 111-113 may each include remote radio heads (RRHs) and/or radio units (RUs), e.g., according to O-RAN definitions. In some examples, satellites or other NTN nodes may also include BBUs, DUs, and/or CUs. For instance, in FIG. 1, satellite 112 may include a BBU 145.

In various examples, one or more NTN nodes may dynamically map to one or more baseband units. For instance, as illustrated in FIG. 1, satellite 111 may establish feeder links with either of ground stations 131 or 132, via which satellite 111 (e.g., a radio unit/RRH thereof) may be associated with one of the BBUs 141 or 142. In addition, satellite 111 may maintain an ISL 175 with satellite 112 by which it may be associated with BBU 145. Thus, RRHs deployed to NTN nodes (e.g., satellites 111-113) may be paired with different BBUs to complete respective disaggregated base stations over a hybrid cellular/NTN network (and similarly for satellite 112 and/or satellite 113).

Each of the satellites 111-113 may have one or more feeder links 171-174) to one or more ground stations (e.g., also referred to as satellite gateways or satellite access nodes), e.g., ground stations (STAs) 131-133. In addition, the satellites 111-113 may have inter-satellite links (ISLs) 175-177 as further illustrated in FIG. 1. In accordance with the present disclosure, satellites 111-113 may each provide cellular network connectivity services to endpoint devices in connection with terrestrial cellular RAN 101. For instance, satellite 111 may serve endpoint device 162 via beam 181. The connection for endpoint device 162 to satellite 111 may be referred to as a “service link” (e.g., service link 178). Notably, satellite 111 may be capable of providing beam coverage anywhere within satellite coverage area 1 (121). However, to support performance (e.g., data rates, throughput, latency, etc.) that is the same or as close as possible to terrestrial cellular service, more focused directional beams may customarily be used (e.g., such as illustrated by beams 181-184). For ease of illustration, only four beams are shown for satellite coverage area 1 (121), where it should be understood that additional beams of a same or similar nature may be provided by satellite 111 in other portions of satellite coverage area 1 (121). Similarly, satellite 112 may offer various beams, such as beams 185-187 within satellite coverage area 2 (122). For example, endpoint device 163 may have a service link 179 with satellite 112 established over beam 187. It should be noted that some beams near the edges of satellite coverage areas 1 and 2 (121 and 122) may be overlapping or partially overlapping (e.g., beams 184, 185, and 186). Thus, an endpoint device in such location(s) may have a choice of different beams.

As discussed in greater detail below, satellite 113 may also offer a beam 188 which may overlap with beams 185-187. In particular, satellite 113 may comprise a high earth orbit (HEO) satellite, such as a geostationary satellite which may be at a substantially higher altitude than satellites 111 and 112. For instance, satellites 111 and 112 may comprise low earth orbit (LEO) or medium earth orbit (MEO) satellites. Accordingly, the satellite coverage area 3 (123) may be substantially larger than the satellite coverage areas 1 and 2 (121 and 122). It should be understood that endpoint devices 161-165 or others may similarly obtain service links with any of satellites 111-113 for which the respective endpoint devices are within an associated one of the satellite coverage areas 1-3 (121-123), and that the corresponding ones of the satellites 111-113 may provide directional beams to support the service links for one or a plurality of such endpoint devices. Similarly, any of the endpoint devices 161-165 may attach to terrestrial cellular network 101 via any of the cell sites 151-154 that is/are within communication range. For ease of illustration, the communication ranges(s) of cell sites 151-154, e.g., cell footprints, and potential links between endpoint devices 161-165 and cell sites 151-154 are omitted from FIG. 1.

It should be noted that FIG. 1 illustrates two architecture modes for extending cellular services across NTN air interfaces to endpoint devices. In particular, in a non-regenerative mode, also referred to as a transparent mode, the uplink may involve a satellite radio unit (RU) or RRH receiving uplink data traffic from endpoint devices via service links, and forwarding the data traffic to a ground station via a feeder link, where the ground station may further pass the data traffic to a baseband unit. For instance, in one example, satellite 111 may receive data traffic from endpoint device 162 via service link 178, and may retransmit the data traffic via feeder link 171 to ground station 131. In turn, ground station 131 may pass the data traffic to one of the BBUs 141 or 142. In another example, satellite 111 may retransmit the data traffic via feeder link 172 to ground station 132, where ground station 132 may pass the data traffic to one of the BBUs 142. The uplink may follow a similar pattern in reverse. For example, uplink data for endpoint device 162 may be received at one of the BBUs 141 or 142, e.g., from a cellular core network element (such as a user plane function (UPF), etc.) and may be forwarded to ground station 131 or 132 for transmission to satellite 111 via feeder link 171 or 172. In either case, the satellite 111 may retransmit the data traffic via service link 178 over beam 181 to endpoint device 162.

In a regenerative model, the entire RAN infrastructure (or at least an RU and DU) may be deployed to a NTN node. For instance, FIG. 1 illustrates that satellite 112 may include a baseband unit 145 (e.g., in addition to an RU/RRH (not shown)). In this case, BBU 145 may establish links/interfaces to cellular core network components (e.g., a UPF, an access management function (AMF), etc.) via ground station 133. While the data flow for serving endpoint device 163 may be similar to the transparent mode, the demarcation points for different RAN and cellular core links/interfaces are different. To further illustrate, satellite 112 may receive uplink data traffic from endpoint device 163 via service link 179. BBU 145 may process the data traffic and may retransmit the data traffic via feeder link 174 to ground station 133. In turn, ground station 133 may pass the data traffic to a cellular core network element/network function (e.g., a UPF, or for management traffic an AMF, etc.). Similarly, ground station 133 may receive uplink data traffic, e.g., from a cellular core network element, and may transmit the data traffic to satellite 112 (e.g., to BBU 145). BBU 145 may process the data traffic and may retransmit the data traffic to endpoint device 163 via service link 179.

It should be noted that BBU 145 may process data traffic not only for endpoint device 163 and/or others having service links to satellite 112, but also for other endpoint devices having service links via other satellites. For instance, in one example, satellite 111 may provide cellular network access to endpoint device 162, e.g., via service link 178. However, satellite 111 may associate itself with BBU 145 rather than a terrestrial-based BBU. In this case, uplink data traffic for endpoint device 162 may be received via service link 178 and retransmitted via inter-satellite link (ISL) 175 to BBU 145. BBU 145 may process the data traffic and in one example may retransmit the data traffic via feeder link 174 to ground station 133 (e.g., for onward forwarding to a cellular core network). Uplink data traffic for the endpoint device(s) 162 may follow a similar path in reverse. The use of regenerative mode and NTN-based BBUs may enable some satellites to continue to provide usable service links to endpoint devices even when a ground station is not visible or within communication range of such satellite, e.g., if the satellite is still able to maintain an ISL with another satellite. In addition, an NTN-based BBU, such as BBU 145, may also enable routing of data traffic between certain endpoint devices without the need to enter or traverse the cellular core network. This can be particularly advantageous where the routing of data traffic over feeder links can be avoided, e.g., resulting in substantial latency savings, etc. For instance, if endpoint device 163 is communicating with endpoint device 164 (e.g., having its own service link to satellite 112 (not shown)), BBU 145 may hairpin the communication through satellite 112 without relay to ground station 133. It should be noted that this type of situation may occur frequently where users may be travelling in a group in the wilderness or traveling on a ship where satellite connectivity may be the only option or the most viable option to maintain connectivity to a cellular network, and where the users may often use their endpoint devices to maintain in voice and text contact when out of direct face-to-face communication range (such as at opposite ends of a ship, when a mile or more apart on a trail, etc.).

As noted above, examples of the present disclosure provide for continuous or nearly continuous cellular network connectivity via a NTN network for wireless access. However, satellite communication was not originally designed for high-speed/high-bandwidth connections for cellular endpoint devices. In addition, satellite communication is generally only used when there is no cellular coverage at all. In contrast, in one example, the present disclosure may extend cellular coverage by pushing satellite service onto low-band narrow-bandwidth channels. In particular, the present disclosure may use low-band spectrum with narrow bandwidth channels to provide wide coverage (e.g., large footprint). For instance, low-band, narrow bandwidth channels may be used for endpoint devices in idle mode, e.g., for paging, endpoint device tracking, session keep alive, etc. In one example, endpoint devices may have temporary spikes in demand for data over satellite and may be provided higher spectrum band and/or wider bandwidth channels, but may be pushed back to low-band, narrow channel, and/or wide coverage beams when temporary high data needs have passed, e.g., switching back to idle mode. In one example, higher satellites, such as those in HEO and/or geostationary orbits, may use lower band beams and provide wider coverage, while satellites with lower orbits, such as MEO or LEO satellites, may be capable of maintaining data connections at higher frequency bands and/or with wider channel bandwidths, but with reduced coverage. In one example, higher satellites may provide service links for control signaling and lower satellites may provide service links for higher data needs for temporary communications, e.g., to send and/or receive a text message, to make a short voice call, etc. For instance, in one example, an endpoint device may be paged for a voice call via a control channel over a service link with a first satellite/satellite beam and may then be provided with a secondary service link via a different satellite/satellite beam with a higher frequency and/or channel width to receive and send voice data.

To further illustrate, in the example of FIG. 1, satellite 113 may comprise a HEO and/or geostationary satellite that may provide idle mode signaling for endpoint device 163 via a service link 191 over beam 188. In one example, the service link 191 may be allocated a narrow bandwidth channel (e.g., 5 MHz or less, 10 MHz or less, or the like) within a low band (e.g., 900 MHz or less, 1100 MHz or less, or the like). Notably, service link 191 may be sufficient to enable control channel monitoring by endpoint device 163, and for paging by satellite 113 (e.g., the RRH/RU thereof, controlled by a BBU, such as one of the BBUs 142 or BBU 145, etc.). However, the narrow bandwidth channel for feeder link 191 may be insufficient when a user of endpoint device 163 may seek to initiate a voice call. In this case, in one example, endpoint device 163 may identify available satellites and/or beams, and may select a beam from among the available beams that may support the desired voice call. For instance, in the present example, it may be possible for endpoint device 163 to establish service links with satellite 113, e.g., via beam 188 or with satellite 112, e.g., via beam 187. In this case, endpoint device 163 already has a feeder link 191 established with satellite 113 via beam 188, which may be insufficient to support the voice call. Accordingly, in such an example, endpoint device 163 may elect to establish service link 179 with satellite 112 over beam 187. For instance, beam 187 may offer higher bandwidth channels, which may be in a higher band than a band associated with beam 188 (e.g., beam 187 may be in the 1.8 GHz or above range, within a C-band (such as 3.7-3.98 GHz), or the like, and may provide channels with channel widths of 20 MHz or greater). Endpoint device 163 may then engage in voice communications over service link 179. For uplink voice data, satellite 112 may process the voice data internally at BBU 145 and may retransmit the voice data to ground station 133 over feeder link 174 for onward transmission to a cellular core network element (e.g., a UPF, etc.) or may act as a repeater by retransmitting the voice data to ground station 133 for forwarding to one of the BBU(s) 143. Downlink voice data may similarly follow one of these paths/processes in reverse.

It should be noted that in one example, if a voice communication is with another endpoint device that is attached to the terrestrial cellular RAN 101 via another satellite connection, such as endpoint device 162, and if satellite 112 is using its own internal BBU 145, the BBU 145 may determine to route the voice call via ISL 175 and satellite 112, e.g., without using feeder link 174 and without traversal of a cellular core network. In one example, service link 191 may be maintained for endpoint device 163, and may continue to be used for control plane signaling while higher data rate service for the voice call may proceed via service link 179. In another example, service link 191 may be released, and all cellular communications for endpoint device 163 may utilize service link 179. In one example, after a need for higher data rates has passed, the endpoint device 163 may then seek to switch back to a service link over a beam providing low band, narrow bandwidth channel(s) for idle mode (such as re-establishing service link 191 via beam 188, via a different beam of satellite 113, or via a beam of a different NTN node). Although the foregoing describes a data communication demand for a voice call, in other examples, higher data demands may similarly relate to engaging in text message communications (e.g., Short Message Service (SMS) messages, Multimedia Messaging Service (MMS) messages, Rich Communications Service (RCS) messages, over-the-top (OTT) messaging application messages, and so forth).

It should be noted that the foregoing is just one example of satellite/beam selection in which a beam of a HEO satellite with a lowband, narrow bandwidth channel may be used for idle mode and where a beam of a LEO satellite with higher band, wider bandwidth channel may be used for higher data demand. However, it should be understood that the present disclosure is not limited to specific bands, bandwidth channels, satellite deployment types, cellular RAN fronthaul architectures, and so forth. For instance, in another example, endpoint device 163 may be at a location at the intersection of beams 184, 185, and 186, and may potentially establish cellular network connectivity via any of these beams. In addition, for illustrative purposes, it may be the case that satellite 113 is not visible to endpoint device 163 or is otherwise unavailable. In this regard, in one example, endpoint device 163 may include selection logic to evaluate and select a best beam from among a plurality of available beams of one or more NTN nodes to establish a service link, and to maintain NTN-based attachment to the terrestrial cellular RAN 101.

For example, the endpoint device 163 may make a determination of a best beam based upon channel bandwidth information for each of the plurality of NTN nodes and/or particular beams thereof. For instance, if the endpoint device 163 is in idle mode, a narrower bandwidth channel may be preferred (which may generally be associated with a lower frequency band). On the other hand, if endpoint device 163 is active and has a current communication demand, e.g., for text, voice, email, or another user data service, the endpoint device 163 may search for a beam with wider bandwidth, e.g., which may support higher data rates and which may generally be associated with higher frequency bands. In various examples, the endpoint device 163 may further consider flightpath information for one or more of the NTN nodes, load information for one or more of the NTN nodes (or for one or more beams of the one or more NTN nodes), signal strength information for one or more beams of the one or more NTN nodes, and so forth. In one example, endpoint device 163 may further consider movement information of the endpoint device 163, such as position/location history, a trajectory (direction and speed), a forecast position, etc. For instance, if a beam or NTN node will only be available for a short time due to the movement of the NTN node and/or the endpoint device 163, it may be preferable to select a different channel and/or NTN node that will be available for a longer period of time. However, if endpoint device 163 determines that the data demand will persist for a duration of time that is less than the anticipated time window over which the beam/NTN node is visible/available, then the endpoint device 163 may still consider the beam/NTN node as a viable candidate. In addition, endpoint device 163 may predict future locations and may seek to pre-establish a new service link in anticipation of being at a future location at a future time, and in advance of releasing an existing/current service link.

Alternatively, or in addition, in one example, endpoint device 163 may further consider a data communication demand for the endpoint device 163, which may be either to or from the endpoint device 163. For instance, for inbound communications, the endpoint device 163 may be paged, e.g., in idle mode, indicating the data volume or anticipated data volume. For instance, for a higher data demand, the endpoint device 163 may look for higher bandwidth channel (which may generally be in a higher frequency band, and which may be provided by a LEO satellite versus a geostationary HEO satellite, which may not be able to offer higher frequency signals due, e.g., due to attenuation over substantially larger distances). For a lower data demand, the endpoint device may look for the lowest bandwidth channel that can just support the data demand, e.g., to upload or download content within a “reasonable” time, which may be an adjustable parameter that may be set based on use preferences and/or an network operator preference. In still another example, endpoint device 163 may alternatively or additionally consider a battery charge condition of the endpoint device 163. For example, the endpoint device 163 may determine that it is too costly to connect to a LEO satellite, such as satellite 112, which may only be temporarily in view, even if it would enable endpoint device 163 to consume less battery charge to connect as compared to other NTN nodes if the satellite 112 were available long term. For example, the power consumption to handover twice could exceed the savings, where it may be better to stay on a low-band narrow-bandwidth connection to a higher satellite, such as satellite 113.

To further illustrate, in one example endpoint device, such as endpoint device 163, may comprise a machine learning model (MLM) that is trained to generate/output a selected set of one or more beams of one or more NTN nodes in response to an input vector comprising information regarding the plurality of NTN nodes and/or information regarding the endpoint device itself. In particular, the MLM may be trained/configured to process an input or a set of inputs (e.g., an input vector) including NTN node information (e.g., the identities/a list of various available NTN nodes and/or available beams thereof), including at least channel bandwidth information for each of the plurality of NTN nodes (e.g., channel bandwidths of the beams thereof), and to generate an output comprising a selection of one or more of the beams. In one example, the input vector may further include endpoint device information, such as: a data communication demand for the endpoint device, a battery charge condition of the endpoint device, one or more preferences associated with the endpoint device (e.g., for satellites of a particular satellite service provider (e.g., one from a same country of origin, one that is “in network”, etc.), cost considerations (such as an “in network” satellite service provider, etc.), battery consumption considerations, and so forth. For instance, such a MLM may be trained to account for historic trends, but at any given time, an optimal beam selection may be more likely to be achieved when particularly taking into account the most recent/most up to date endpoint device information and/or NTN node information. Accordingly, in one example, this may be incorporated into the input vector at runtime (e.g., when endpoint device 163 is making a beam selection). However, in another example, the NTN node information may be fully accounted for within the training of MLM. For instance, the MLM may be retrained periodically or otherwise, or may be updated on an ongoing basis, e.g., via reinforcement learning (RL) or the like, to keep the MLM current. In addition, insofar as non-stationary NTN nodes have orbits that are fixed/predictable, time, date, and/or other temporal factors may also be embedded within the training of the MLM.

Thus, from any or all of these input factors, or the like, and based upon model training using historic data patterns, a trained MLM of endpoint device 163 (and/or others of the endpoint devices 161-165) may thus generate an output comprising one or more selected beams. In one example, training data may comprise labeled records of endpoint device to beam assignments. For instance, in one example, the labels may indicate whether the assignment was “successful” or “unsuccessful.” To illustrate, users may provide feedback via an endpoint device of whether the service was acceptable or not acceptable (e.g., in terms of the ability to transmit and receive data and/or in terms of battery charge consumption, etc.). Alternatively, or in addition, a network operator may set one or more thresholds and/or may use one or more formulas to determine whether an assignment was successful or not. For instance, if a call drop rate, a call block rate, latency metrics, throughput metrics, or the like fail to meet one or more performance thresholds/benchmarks, the assignment may be labeled as unsuccessful (otherwise a label of “successful” may be applied). In still another example, the labels may be on a scale, such as 1-5, 1-10, 0-10, 0-100, etc. indicating a level or percentage of success (or lack thereof). For instance, a formula may be based on one or more of the foregoing factors (e.g., call drop rate, call block rate, latency, throughput, etc.), where an output “score” or value may indicate the relative level of success. This label may then be used in conjunction with corresponding records data regarding the endpoint device beam selections/assignments as training data for MLM training. In one example, the training data may be specific to the endpoint device training and operating the MLM, such as endpoint device 163. Alternatively, or in addition, the training data may be from various endpoint devices that may have operated within an area. In one example, MLM training may be performed offline, e.g., in a network-based server associated with terrestrial cellular RAN 101 and deployed/provided to one or more endpoint devices for use.

It should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

In one example, MLMs of the present disclosure may include an ML-based generative model, such as a language model, e.g., a “large language model” (LLM). For instance, a ML-based generative model used in the present examples may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. In one example, the present disclosure may fine-tune a base language model or may custom-build a language model to provide high-level instructions for radio access network (RAN), cellular network, and/or satellite network-specific issues. In addition, in one example, the present disclosure may further enhance such a fine-tuned MLM to provide concrete, actionable instructions, e.g., NTN node to BBU assignments/mappings. For instance, a generative language model of the present disclosure may further include a retrieval augmented generation (RAG) process loop to index network equipment and/or network function vendor documentation, network operator internal documents, cellular technology technical standards, such as 3rd Generation Partnership Project (3GPP) technical standards (TS), or the like in a vector store, as well as current NTN node information (e.g., associated with satellite 111-113, the beams thereof, etc.) and/or endpoint device information such as described above. In one example, input data for such a LLM-based generative model may include converting categorical or numerical data to text form, as well as vectorization of textual data to vectors (e.g., via word2vec, doc2vec, Global Vectors for Word Embedding (GloVe), or the like, using n-grams, and so forth). In one example, tailored prompts may be used in connection with a generative MLM of the present disclosure, e.g., to obtain outputs that may comprise instructions in useable format with respect to other network functions, such as outputs formatted for 3GPP/5G standards compliant communications, IEEE 802.11 standards compliant communications, or the like. For instance, the prompt may explicitly request a selection of one or more beams of one or more NTN nodes, e.g., where the prompt may list the available NTN nodes/beams and/or where further information about the NTN nodes, beams, and/or the subject endpoint device may be obtained for appending as RAG content.

In one example, the endpoint device, such as endpoint device 163 may have direct awareness of its own status information (e.g., by maintaining records of such metric(s)), such as data demand, movement, location, battery condition, etc. In addition, endpoint device 163 may obtain NTN node/beam information from one or more NTN nodes (e.g., satellites 111-113) over an existing service link. For instance, endpoint device 163 may maintain at least one existing service link (e.g., service link 191) while evaluating whether to hop to a different beam from the same or a different NTN node. In addition, the NTN nodes, such as satellites 111-113 may share information regarding beam load/availability, etc. with each other via ISLs 175-177 such that any one of the satellites 111-113 may provide such information to endpoint device 163. In one example, endpoint device 163 may continue to gather performance data to determine whether beam selections are “successful”/“unsuccessful” or the like, e.g., where endpoint device 163 and/or a network-based server may use the performance data as labels for MLM training/retraining (e.g., automated machine learning (autoML)). Thus, for example, endpoint device 163 executing such a MLM may determine that beam 187 is available and that endpoint device 163 should establish a service link 179 to satellite 112 over such beam based upon any or all of the above factors, such as channel beamwidths, signal strength, satellite and/or beam loads associated with a plurality of beams, satellite trajectories of one or more satellites, etc., user/endpoint device preferences for particular satellites or NTN network providers, preferences for power consumption/battery savings, endpoint device data demand, endpoint device location, movement, and so forth.

It should be noted that FIG. 1 illustrates (and the foregoing describes) just several examples in accordance with the present disclosure. Thus, it should be appreciated that other, further, and different examples may readily be devised in accordance with the present disclosure. As just one example, the system 100 may alternatively or additionally include NTN nodes of varying types, such as balloons, UAVs, etc. In still another example, an endpoint device may be in a very low battery mode, where it may minimally ping the network to give breadcrumbs/footprints before it loses power completely. For instance, there may be insufficient satellite visibility to obtain or to determine a location via Global Positioning System (GPS), but a single narrow beam may be available that is localized enough to give a clue as to where the endpoint device is located. In one example, the endpoint device may select to not initiate an attachment to a satellite with a wide beam or coverage area because it is not precise enough to be useful to locate the endpoint device in an emergency. To further illustrate, it is possible that there may be only one satellite visible while an endpoint device has 10 minutes of battery power left. In one example, it may elect to attach to a satellite via a service link over a wide beam if it is the only one available. Otherwise the endpoint device may select to wait to attach to another satellite that may be able to establish a service link over a narrower beam (if there is still sufficient battery charge available to make connection that could require more transmit power). Alternatively, or in addition, the endpoint device may use knowledge of satellite movements (that could be stored into the endpoint device) to know that a satellite with narrower beam should become visible in next 5 minutes, in which case the endpoint device could wait to attach to that satellite, which can give a more accurate location estimate.

It should be noted that in some examples, the satellite network (e.g., satellites 111-113 and ground stations 131-133) may be controlled and/or operated by one or more entities that are different from the terrestrial cellular RAN and/or a cellular core network associated therewith. As such, in different examples, satellite access components (e.g., satellites 111-113 and ground stations 131-133) may be designated as trusted or untrusted, such that data ingress and egress to the cellular core network may be via shared gateway, a security gateway (SeGW), and/or a non-3GPP inter-working function (N3IWF) (e.g., a non-cellular network interworking function). In particular, a N3IWF enables protocol data unit (PDU) session establishment via a UPF for endpoint devices connecting to external networks beyond the cellular core via trusted and untrusted non-cellular (e.g., non-3GPP) access networks. These can include IEEE 802.11/Wi-Fi networks, and in accordance with the present disclosure, may further include satellite access networks. In this regard, it should also be noted that the terrestrial cellular RAN 101 may also interface with one or more cellular core networks, some or all of which may be operated by a different entity other than the terrestrial cellular RAN 101. For example, the terrestrial cellular RAN 101 may comprise a private cellular network or a RAN of a peer cellular network. For instance, in one example, terrestrial cellular RAN 101 may be made available by a host mobile network operator (MNO) that provides for shared use of terrestrial cellular RAN 101 by one or more other MNOs, e.g., those operating one or more cellular core networks.

In addition, the foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For instance, intermediate devices and links between cell sites 151-154 or BBUs 141-143 and other components of system 100 are omitted for clarity, such as additional routers, switches, gateways, and the like. Likewise, links to one or more cellular core networks are also omitted for ease of illustration. Thus, these and other modifications are all contemplated within the scope of the present disclosure.

FIG. 2 illustrates a flowchart of an example method 200 for selecting at least one beam of at least one non-terrestrial network node from among a plurality of non-terrestrial network nodes for establishing a cellular network connection for an endpoint device based on information regarding the plurality of non-terrestrial network nodes including channel bandwidth information, in accordance with the present disclosure. In one example, steps, functions and/or operations of the method 200 may be performed by a device as illustrated in FIG. 1, e.g., one of endpoint devices 161-165, or collectively via a plurality devices in FIG. 1, such as one of endpoint devices 161-165 in conjunction with one or more satellites 111-113 (e.g., NTN nodes), and so forth. In one example, the steps, functions, or operations of method 200 may be performed by a computing device or system 300, and/or a processing system 302 as described in connection with FIG. 3 below. For instance, the computing device or system 300 may represent at least a portion of device or system deployed in a cellular network that is configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a processing system, such as processing system 302. The method 200 begins in step 205 and proceeds to step 210.

At step 210, the processing system (e.g., of a cellular endpoint device) obtains information regarding a plurality of non-terrestrial network (NTN) nodes of a non-terrestrial network, wherein the information includes channel bandwidth information for each of the plurality of NTN nodes (e.g., channel bandwidths associated with different beams of each of the plurality of NTN nodes). In various examples, the information regarding the plurality of NTN nodes may further include flightpath information for one or more of the NTN nodes, load information for one or more of the NTN nodes (e.g., for one or more beams of the one or more NTN nodes), signal strength information for one or more beams of the one or more NTN nodes, and so forth.

At optional step 220, the processing system may detect at least one trigger condition, where the at least one trigger condition may include one or more of: a movement of the endpoint device (e.g., moving out of a coverage area of a current serving NTN node, beam, or the like), a data communication demand for the endpoint device (e.g., a new communication either to or from the endpoint device), a battery charge condition of the endpoint device (e.g., falling below a threshold or the like), or a movement of a NTN node via which the endpoint device has an established cellular network connection (e.g., a second cellular network connection via at least a second beam).

At step 230, the processing system selects, based on at least the information regarding the plurality of NTN nodes, at least one beam of at least one NTN node from among the plurality of NTN nodes for establishing a cellular network connection via the non-terrestrial network. In various examples, the selecting may be further based on one or more aspects of endpoint device information, such as movement information of the endpoint device (e.g., position/location history, a trajectory (direction and speed), a forecast position, etc.), a data communication demand for the endpoint device, and/or a battery charge condition of the endpoint device.

In this regard, in one example, the processing system may implement a selection logic to evaluate and select a best beam from among a plurality of available beams of one or more NTN nodes to establish a service link for a cellular network connection for the endpoint device, e.g., using some or all of the above factors, or the like. For instance, if the endpoint device is in idle mode, a narrower bandwidth channel may be preferred (which may generally be associated with a lower frequency band). On the other hand, if the endpoint device is active and has a current communication demand, e.g., for text, voice, email, or other user data services, the endpoint device may search for a beam with wider bandwidth, e.g., which may support higher data rates and which may generally be associated with higher frequency bands.

In one example, the selecting may be via a machine learning model (MLM) implemented by the processing system that is configured to generate an output comprising a selected set of one or more beams of one or more NTN nodes in response to an input vector comprising at least a portion of the information regarding the plurality of NTN nodes. For instance, the MLM may comprise a CNN, a RNN, a decision tree, a generative MLM as discussed above, such as a GAN, a language model (e.g., a LLM), and so forth. In one example, the input vector may further include endpoint device information such as one or more of: a data communication demand for the endpoint device, a battery charge condition of the endpoint device, one or more preferences associated with the endpoint device (e.g., for satellites of a particular satellite service provider (e.g., one from a same country of origin, one that is “in network”, etc.), cost considerations (such as an “in network” satellite service provider, etc.), battery consumption considerations, etc.), and so forth.

At step 240, the processing system establishes the cellular network connection via the at least one beam that is selected. For instance, the cellular network connection may comprise a service link between the endpoint device and the NTN node. In one example, step 240 may further include establishing an N1 link to an AMF in a cellular core network, establishing a PDU session, e.g., via a UPF in the cellular core network, and so forth.

At optional step 250, the processing system may release a second cellular network connection when the cellular network connection is established via the at least one beam at the preceding step 240. For instance, as noted above, the endpoint device may maintain a second cellular network connection via a second beam of a same or a different NTN node, which in one example may be released when a new cellular connection is established at step 240, and which in another example may continue to be maintained while the new cellular network connection is used. For example, the second beam may be of a narrower bandwidth channel as compared to the at least one beam (for instance the new cellular network connection can be via a LEO with higher bandwidth channel, e.g., for active/non-idle mode). To illustrate, the second cellular network connection via the second beam may be for idle mode paging while the at least one beam may be for active user data traffic (e.g., e911, voice, text, email, etc.). Alternatively, or in addition, the second beam may be of a lower frequency band as compared to the at least one beam.

At optional step 260, the processing system may process (e.g., transmit and/or receive) data traffic for the endpoint device over the cellular network connection via the at least one beam. For example, the endpoint device may communicate wirelessly with a RRH of the NTN node via a service link over the at least one beam in the same or a similar manner as if the endpoint device was communicating with a terrestrial RRH, e.g., via a Uu interface.

At optional step 270, the processing system may release the cellular network connection when a demand for the data traffic is completed. For instance, in the case that the second cellular network connection is maintained, the endpoint device may remain attached to a cellular RAN via the second cellular network connection. At the same time, the resources of the cellular network connection over the at least one beam may be released for reuse by other endpoint devices, and which in some cases may result in further power savings at the NTN node and/or endpoint device.

Following step 240 or one of optional steps 250-270, the method 200 proceeds to step 295 where the method 200 ends.

It should be noted that the method 200 may be expanded to include additional steps or may be modified to include additional operations with respect to the steps outlined above. For example, the method 200 may be repeated on an ongoing basis to perform steps 210-220, steps 210-260, steps 220-240, etc. In one example, the method 200 may be expanded to include training the MLM that may be implemented at step 230. In such example, the method 200 may further include collecting labels/feedback from endpoint devices and/or performance data from network components for sample labeling and for MLM training/retraining, and so forth. In one example, the method 200 may further include increasing a time interval for control channel scanning, e.g., sparse PDCCH scanning and/or searching within a narrower frequency band, e.g., for additional idle mode power savings. In one example, the method 200 may be expanded or modified to include steps, functions, and/or operations, or other features described in connection with the example(s) of FIG. 1, or as described elsewhere herein. Thus, these and other modifications are all contemplated within the scope of the present disclosure.

In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. For example, any one or more components or devices illustrated in FIG. 1 or described in connection with the example method 200 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for selecting at least one beam of at least one non-terrestrial network node from among a plurality of non-terrestrial network nodes for establishing a cellular network connection for an endpoint device based on information regarding the plurality of non-terrestrial network nodes including channel bandwidth information, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 306 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for selecting at least one beam of at least one non-terrestrial network node from among a plurality of non-terrestrial network nodes for establishing a cellular network connection for an endpoint device based on information regarding the plurality of non-terrestrial network nodes including channel bandwidth information (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for selecting at least one beam of at least one non-terrestrial network node from among a plurality of non-terrestrial network nodes for establishing a cellular network connection for an endpoint device based on information regarding the plurality of non-terrestrial network nodes including channel bandwidth information (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor of a cellular endpoint device, information regarding a plurality of non-terrestrial network nodes of a non-terrestrial network, wherein the information includes channel bandwidth information for each of the plurality of non-terrestrial network nodes;
selecting, by the processing system based on the information regarding the plurality of non-terrestrial network nodes, at least one beam of at least one non-terrestrial network node from among the plurality of non-terrestrial network nodes for establishing a cellular network connection via the non-terrestrial network; and
establishing, by the processing system, the cellular network connection via the at least one beam.

2. The method of claim 1 wherein the cellular network connection comprises a service link between the cellular endpoint device and the at least one non-terrestrial network node.

3. The method of claim 1, wherein the information regarding the plurality of non-terrestrial network nodes further includes at least one of:
flightpath information for at least one of the plurality of non-terrestrial network nodes;
load information for the plurality of non-terrestrial network nodes; or
signal strength information for a plurality of beams of the plurality of non-terrestrial network nodes.

4. The method of claim 1, further comprising:
detecting at least one trigger condition, wherein the at least one trigger condition comprises at least one of:
a movement of the cellular endpoint device;
a data communication demand for the cellular endpoint device;
a battery charge condition of the cellular endpoint device; or
a movement of at least a second non-terrestrial network node via which the cellular endpoint device has a second cellular network connection via at least a second beam.

5. The method of claim 4, wherein the selecting and the establishing are performed in response to the detecting the at least one trigger condition.

6. The method of claim 1, wherein the selecting is further based upon movement information of the cellular endpoint device.

7. The method of claim 1, wherein the selecting is further based upon a data communication demand for the cellular endpoint device.

8. The method of claim 1, wherein the selecting is further based upon a battery charge condition of the cellular endpoint device.

9. The method of claim 1, further comprising:
processing data traffic for the cellular endpoint device over the cellular network connection via the at least one beam.

10. The method of claim 9, wherein the cellular endpoint device maintains a second cellular network connection via a second beam.

11. The method of claim 10, further comprising:
releasing the cellular network connection when a demand for the data traffic is completed.

12. The method of claim 10, wherein the second beam comprises a narrower frequency channel as compared to the at least one beam.

13. The method of claim 12, wherein the second beam comprises a lower frequency band as compared to the at least one beam.

14. The method of claim 10, wherein the second cellular network connection via the second beam is for idle mode paging.

15. The method of claim 10, further comprising:
releasing the second cellular network connection when the cellular network connection is established via the at least one beam.

16. The method of claim 15, wherein the cellular network connection is for idle mode paging.

17. The method of claim 1, wherein the selecting is via a machine learning model implemented by the processing system that is configured to generate an output comprising a selected set of one or more beams of one or more non-terrestrial network nodes in response to an input vector comprising at least a portion of the information regarding the plurality of non-terrestrial network nodes.

18. The method of claim 17, wherein the input vector further includes one or more of:
movement information of the cellular endpoint device;
a data communication demand for the cellular endpoint device;
a battery charge condition of the cellular endpoint device; or
one or more preferences associated with the cellular endpoint device.

19. A non-transitory computer-readable medium storing instructions which, when executed by a processing system including at least one processor of a cellular endpoint device, cause the processing system to perform operations, the operations comprising:
obtaining information regarding a plurality of non-terrestrial network nodes of a non-terrestrial network, wherein the information includes channel bandwidth information for each of the plurality of non-terrestrial network nodes;
selecting, based on the information regarding the plurality of non-terrestrial network nodes, at least one beam of at least one non-terrestrial network node from among the plurality of non-terrestrial network nodes for establishing a cellular network connection via the non-terrestrial network; and
establishing the cellular network connection via the at least one beam.

20. A cellular endpoint device comprising:
a processing system including at least one processor; and
a non-transitory computer-readable medium storing instructions which, when executed by the processing system, cause the processing system to perform operations, the operations comprising:
obtaining information regarding a plurality of non-terrestrial network nodes of a non-terrestrial network, wherein the information includes channel bandwidth information for each of the plurality of non-terrestrial network nodes;
selecting, based on the information regarding the plurality of non-terrestrial network nodes, at least one beam of at least one non-terrestrial network node from among the plurality of non-terrestrial network nodes for establishing a cellular network connection via the non-terrestrial network; and
establishing the cellular network connection via the at least one beam.
